(19) United States
(12) Patent Application Publication
(10) Pub. No.: US 2020/0256782 A1
(43) Pub. Date: Aug. 13, 2020

(54) PARTICLE COUNTER COMPONENT CALIBRATION

(71) Applicant: TSI Incorporated, Shoreview, MN (US)

(72) Inventors: Peter Perkins Hairston, North Oaks, MN (US); Frederick R. Quant, Shoreview, MN (US)

(21) Appl. No.: 16/754,703

(22) PCT Filed: Oct. 8, 2018
(86) PCT No.: PCT/US18/54869

§ 371 Date: Apr. 8, 2020

Related U.S. Application Data
(60) Provisional application No. 62/569,726, filed on Oct. 9, 2017.

(51) Int. Cl. G01N 15/14

(52) U.S. Cl. CPC G01N 15/1429; G01N 2015/1486; G01N 15/1434

(57) ABSTRACT

Various embodiments include methods and systems to calibrate a gain of a photodetector. A method can include providing, by a reference light source, first light to a reference photodetector, determining, by controller circuitry, whether a first value from the reference photodetector produced in response to the first light is within a range of acceptable reference photodetector values, in response to determining the first value is within the range of acceptable reference photodetector values, providing, by the reference light source, second light to a measurement photodetector, determining, by the controller circuitry, whether a second value from the measurement photodetector produced in response to the second light is within a range of acceptable measurement photodetector values, and in response to determining the second value is not within the range of acceptable measurement photodetector values, adjusting a gain of the measurement photodetector.

### CLAIM OF PRIORITY

This application claims the benefit of priority to U.S. Provisional Application Ser. No. 62/569,726, filed on Oct. 9, 2017, the contents of which are incorporated herein by reference in its entirety.

### TECHNICAL FIELD

The subject matter disclosed herein relates to high sensitivity photodetectors (HSPD), and, more specifically, to calibration of an HSPD.

### BACKGROUND

HSPDs such as photomultiplier tubes (PMTs), avalanche photodiodes (APDs), and charge-coupled devices (CCDs) are used in a wide variety of applications, such as flow cytometers, aerosol particle detectors, spectrometers, scintillation detectors, nephelometers, and astronomical instruments. A flow cytometer is a light-based technology for cell counting, cell sorting, biomarker detection and protein engineering. A particle detector is a light-based particle classification device. A spectrometer records and measures properties of light, such as to classify a material. A scintillation detector detects luminescence in response to excitation from ionizing radiation. A nephelometer is an instrument for measuring a size and concentration of particles suspended in a liquid or gas.

### BRIEF DESCRIPTION OF THE FIGURES

FIG. 1 illustrates, by way of example, a diagram of an embodiment of a device for particle counting or classification.

FIG. 2 illustrates, by way of example, a diagram of an embodiment of a viability detector.

FIG. 3 illustrates, by way of example, a diagram of an embodiment of a viability detector that includes controller circuitry for calibration.

FIG. 4 illustrates, by way of example, a top-view diagram of an embodiment of a viability detector.

FIG. 5 illustrates, by way of example, a side-view diagram of an embodiment of a device.

FIG. 6 illustrates, by way of example, a diagram of a method for calibrating a reference light source that can be used to calibrate a measurement photodetector (e.g., a photodetector of FIG. 2, 3, 4, or 5)

FIG. 7 illustrates, by way of example, a diagram of a method for calibrating a measurement photodetector using the calibrated reference light source of FIG. 6.

FIG. 8 illustrates, by way of example, a diagram of an embodiment of a computing device.

### DETAILED DESCRIPTION

Instruments incorporating an HSPD (e.g., an APD, a PMT, or a CCD) can be compromised by a drift in the sensitivity (e.g., gain) thereof. High sensitivity optical devices, like PMTs and APDs, have been found to be compromised by drift in the sensitivity (gain) thereof. This includes sensitivity changes (drift) due to warm-up, recovery from storage, bias voltage, temperature, static changes magnetic fields, and long-term sensitivity change due to aging. While several methods exist for calibrating the gain of such detectors, these methods require intervention by an operator and are not fully automated. Current solutions to calibrate a measurement photodetector (e.g., an HSPD) include placing an object, such as a reference sphere, that reflects a known amount of light in a light path of a laser. The light reflected from the laser light is of a known amount, and a gain of the measurement photodetector is adjusted until the measurement photodetector records the known amount. Further, such calibrations do not allow, without operator intervention, for detecting when a device requires calibration, thus leaving potential for use of an un-calibrated device.

Methods, devices, and systems for calibrating a sensitivity or gain of measurement photodetector are described. The sensitivity or operation of a measurement photodetector, an APD, CCD, or PMT, varies with one or more physical parameter, such as bias voltage, temperature, operating lifetime, operating environment, over exposure, and storage times. Embodiments include a reference light source and a reference photodetector with an instrument. The reference light source can be controlled in an automated fashion, such as by a computing device. The reference photodetector can include a stable light sensing detector, such as a silicon photodiode (SiPD) or a thermopile. The reference light source can then be used to calibrate and stabilize a measurement photodetector of the instrument. Operation of the reference light source calibration, and the measurement photodetector calibration, can be controlled by a programmable computing device. The computing device can be configured to conduct the calibrations at prescribed time intervals, dates, clock times, when operating conditions change, or on demand, such as by issuing one or more instructions to the computing device. Further, the computing device can report (e.g., provide one or more signals indicative of) whether the measurement photodetector is found to be already in calibration such that previous data is reliable, and whether the calibration is successful.

Several types of instruments use a measurement photodetector (e.g., an APD, PMT, or CCD). A measurement photodetector can be difficult to maintain at a constant sensitivity. This difficulty can lead to a more frequent need for calibration or calibration check, more variability in the instrument data, or more uncertainty in the accuracy and reliability of the data. Embodiments provide better data reliability, potential for less frequent calibration, or the ability of users to confirm the accuracy of data as needed. Embodiments can also be applied to other instruments, such as instruments that require accurate, highly-sensitive measurements of light pulses, such a flow cytometers. Photon counting methods of PMT stabilization are not suitable for applications, such as particle characterization, in which some signals are sufficiently short in time and bright in signal intensity, such that individual photon signals “pile up” and cannot be individually resolved. Photon counting methods are not suitable for some detectors, such as single-element APDs, for which photon counting is not practical.

Areas in which the embodiments can be applied include, but are not limited to: biological aerosol monitoring and detection (e.g., for monitoring clean areas, such as pharmaceutical processing clean areas); detection of bacteria in water (e.g., especially ultrapure water, such as for pharmaceutical processing); control of a measurement photodetector, such as an APD, CCD, or a PMT for particle counting and sizing or measurement of fluid flows, such as laser Doppler velocimetry and particle image velocimetry; and flow cytometry.

An APD is a high sensitivity semiconductor device that uses a photoelectric effect to convert light to electricity. An APD uses avalanche multiplication to increase sensitivity thereof. An APD can generally be regarded as a photodetector with a gain stage that operates using avalanche multiplication. A PMT is a photoemissive device. In a PMT, absorption of a photon results in an emission of one or multiple electrons. A PMT operates using a photocathode. A PMT uses one or more dynodes to multiply electrons, creating gain to the initial photoemissions and an anode to collect the resulting electrons multiplied by the dynodes. A CCD moves electrical charge. The amount of electrical charge can he converted to a digital value. A CCD generally moves charge between capacitive bins of the device.

An auto-calibration procedure can address both the early on-set drift and aging sensitivity changes. The auto-calibration procedure can help identify or report when a device is out-of-calibration, rather than having the out-of-calibration be found only at scheduled calibration checks. Assurance that a device is within proper calibration can be important for applications requiring accurate, reliably consistent, and repeatable measurements. Consequently, an auto-calibration function can increase applications for a device and provide a significant competitive advantage. In addition, such calibration can save costs by providing more efficient production and less unbillable service activity.

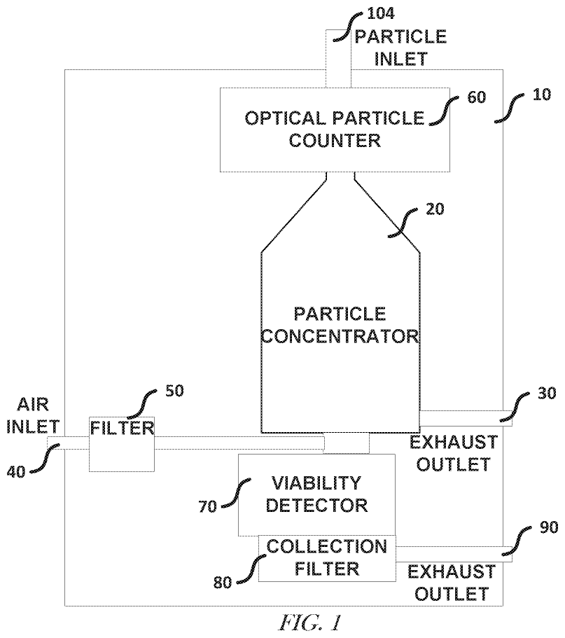

FIG. 1 illustrates, by way of example, a diagram of an embodiment of a device 10 for particle classification or counting. The device 10 as illustrated includes a particle inlet 104, an optical particle counter (OPC) 60, a particle concentrator 20, an exhaust outlet 30, an air inlet 40, an air filter 50, a viability detector 70, a collection filter 80, and an exhaust outlet 90. For proper operation of the device 10, one or more components of the OPC 60 or viability detector 70 should be calibrated.

Particles flow through the particle inlet 104 to the OPC 60. The particle inlet 104 can include a conduit, a pipe, a nozzle, or the like. The OPC 60 quantifies (determines a number of) particles from the particle inlet 104. The OPC 60 can use light scattered from the particles to determine a general count of the number of particles.

The particle concentrator 20 reduces flow of particles through the device 10. The sensitivity of an optical particle sensor is proportional to the sample flow rate. Restated, the amount of detected light is proportional to the time a particle is present in a light beam of a given intensity. The intrinsic fluorescence from microbes is much smaller (by a factor of 10⁻² to 10⁻³) than the scattered light, so adequately detecting fluorescence is not practical at higher flow rates possible using the OPC 60. To obtain a usefully high sampled flow rate and a useful measurement of particle fluorescence, the particle concentrator 20 can be used to deliver particles from a higher OPC 60 sample flow into the lower flow rate for fluorescence measurement, as performed by the viability detector 70. The particle concentrator 20 generally increases a sensitivity of the device 10 to fluorescence.

The exhaust outlet 30 removes excess fluid, such as to aid the particle concentrator 20 in reducing flow. The air inlet 40 provides mobility to gas or particles downstream from the particle concentrator 20. The filter 50 removes particulates from the fluid flowing in the air inlet 40. The filter 50 can help ensure that particles collected at the collection filter 80 are from the particle inlet 104.

The viability detector 70 can perform laser induced fluorescence (LIF) detection of particle viability. Particles that are inert have a different scattering fingerprint than particles that are viable (e.g., are living, such as bacteria). The viability detector 70 can use one or more discrimination parameters for each particle. For example, the viability detector 70 can use one or more of a fluorescence in a first waveband, a fluorescence in a second waveband, and scattered light. More details regarding the viability detector 70 and calibration of components of the viability detector 70 are discussed regarding other figures.

The collection filter 80 collects particles analyzed by the viability detector 70. The collection filter 80 can preserve a sample collected particle, such as for subsequent speciation. The exhaust outlet 90 removes fluid and particles not collected at the collection filter 80 from the device 10.

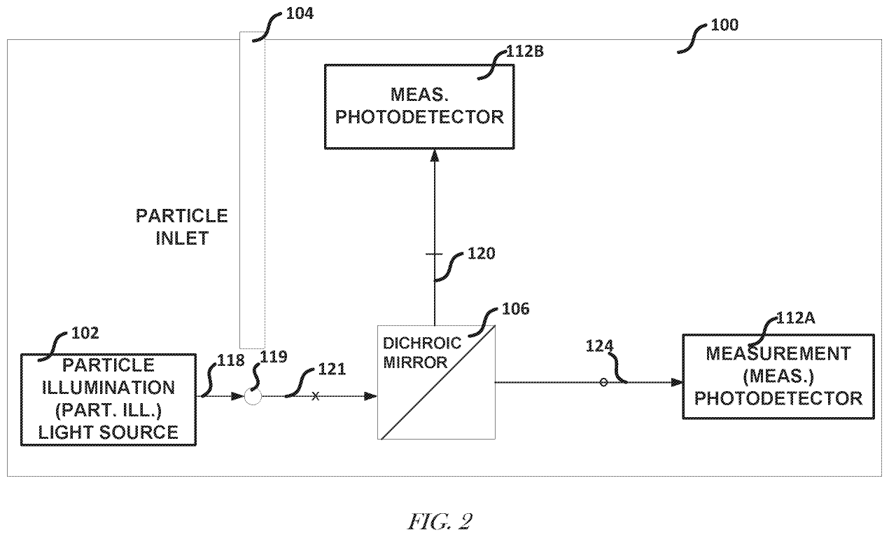

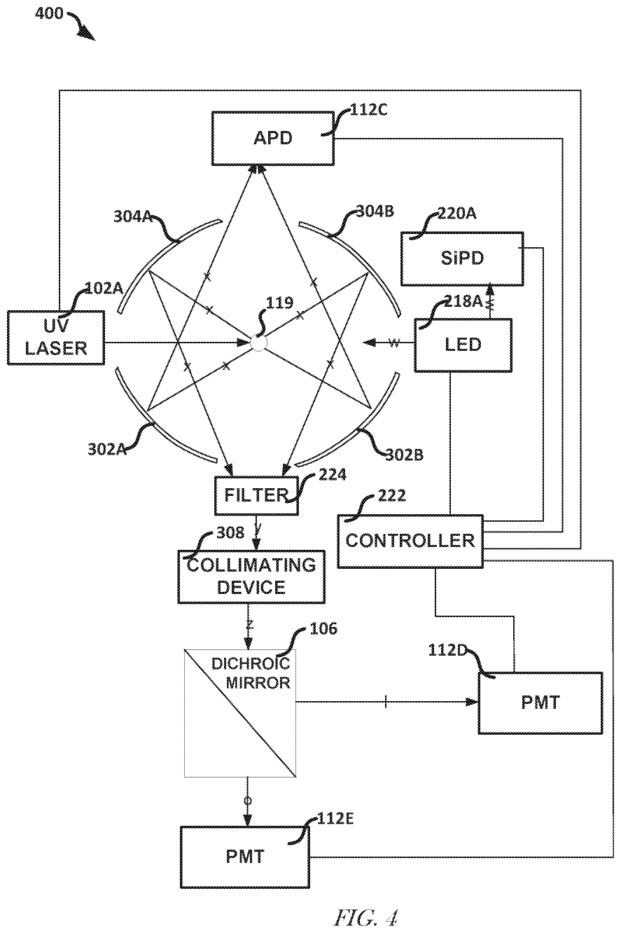

As embodied, the device 100 includes an optical measurement mechanism to determine whether each sampled aerosol particle is viable, such as consisting of or containing one or more microbial particles capable of reproduction. This determination can be based on measurement of the scattered light and intrinsic fluorescence of each particle when illuminated by a light source (e.g., a near ultraviolet (UV) laser light source). The scattered light intensity can be measured using an APD, or other measurement photodetector. An intrinsic fluorescence can be measured in one or more distinct wavelength bands by PMTs. The wavelength bands can be selected by a near UV blocking filter, a dichroic color separation filter (see FIGS. 2-4), and an optical bandpass filter located in the optical path from the illuminated particle to the PMTS (see FIG. 4).

For initial design determinations, a gain response of the photodetector 112A, 112B, 112C, 112D, or 112E (see FIGS. 2-5) for the scattered light intensity and the intrinsic fluorescence can be measured for a variety of microorganisms, using a predetermined sensitivity setting of a measurement photodetector. The predetermined settings can be based on measurement of standardized calibration particles containing a fluorescent dye, with the fluorescence excitation and emission wavelengths of the calibration particles overlapping a wavelength emitted by a particle illumination light source 102 (see FIG. 2, for example) and the measurement photodetector 112A-112E detection wavelength bands. Maintaining the gain responses of the photodetectors 112A-112E to the values set by the calibration particles is important for discriminating viable particles from non-viable particles. Further, checking the instrument with calibration particles on a regular basis is time consuming, expensive, and inconvenient in cases, such as in which the instrument is in a clean area where calibration particles cannot be used.

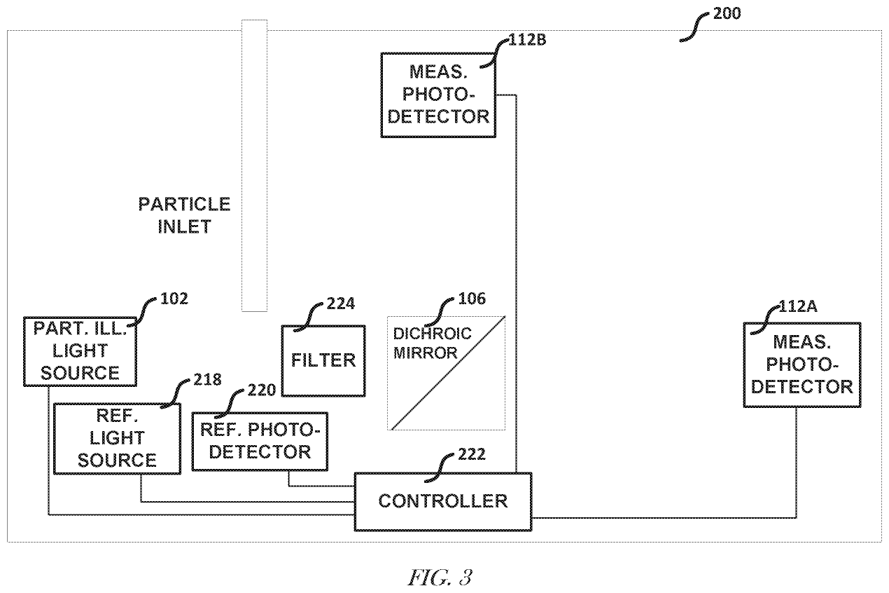

FIG. 2 illustrates, by way of example, a diagram of an embodiment of a device 100 for particle counting or classification. Device 100 includes one or more components that can be included in the device 10, such as the OPC 60 or the viability detector 70 (see FIG. 1). The device 100 as illustrated includes a particle illumination light source 102, the particle inlet 104, a dichroic mirror 106, a first measurement photodetector 112A, and a second measurement photodetector 112B. The particle illumination light source 102 can include a laser, such as a near ultraviolet (UV) laser, or another light source. A measurement photodetector is one that is used to produce data to be used in performing operations of the device 100. A reference photodetector (see FIGS. 3-5) is one that is dedicated to calibrating the measurement photodetector.

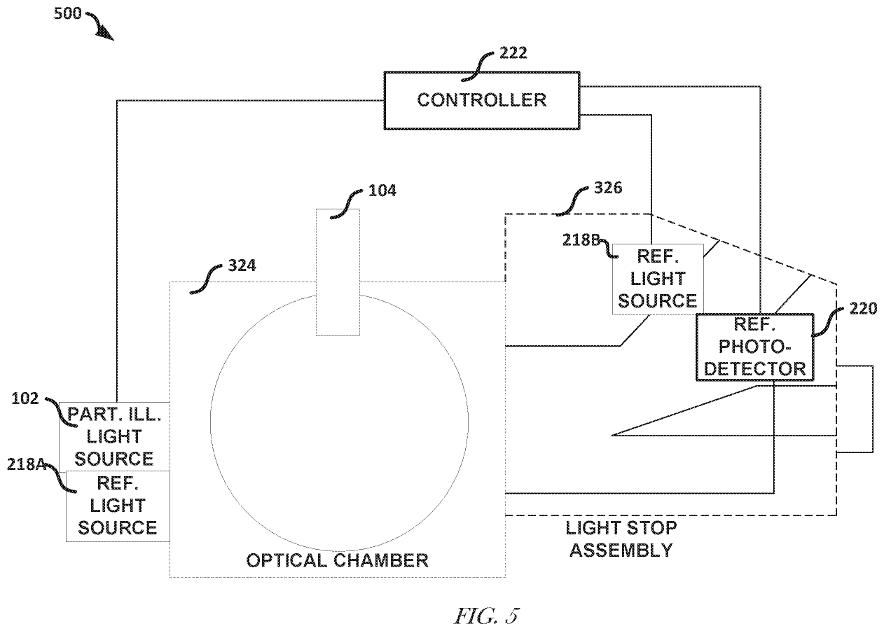

The particle inlet 104 provides a cavity through which a sample can be introduced into a chamber housing selected components of the device 100 (see FIG. 5 for a view of the chamber). Light 118 from the particle illumination light source 102 can be scattered upon contact with a particle 119 introduced through the inlet 104 creating scattered light 121. Particles have varied sizes, shapes, reflection properties, or the like. These differences in particles provide the particles with a scattering fingerprint. The fingerprint can include a distinctive amount of fluorescence, wavelength, or angle of light 121 scattered from the particle 119.

The dichroic mirror 106 receives scattered light 121. The dichroic mirror 106 allows light 124 of a first range of colors (wavelengths) to pass therethrough to the first measurement photodetector 112A and redirects light 120 of a second, different range of colors to the second measurement photodetector 112B.

The measurement photodetector 112A or 112B can include a PMT, APD, or CCD, for example. The measurement photodetector 112A or 112B can include a gain stage that multiplies an electrical signal by a constant value to produce a more detectable signal. An amount of electrical signal produced by the measurement photodetector 112A or 112B can be equal to the amount of light incident thereon multiplied by a constant (gain or sensitivity). The measurement photodetector 112A or 112B can produce an electrical signal to enable measuring the fluorescence amplitude, or other characteristic of the light 124 or 128, respectively, such by using an analog-to-digital converter. The discrimination between viable and non-viable particles by, at least in part, measurement photodetector 112A or 112E is dependent on the sensitivity of the measurement photodetector 112A or 112B, respectively. The sensitivity of the measurement photodetector 112A or 112B may change with time, temperature, age, shelf tune, or other intrinsic or extrinsic influences. For proper operation of the device 100, the measurement photodetector 112A or 112B should have a controlled sensitivity.

FIG. 3 illustrates, by way of example, a diagram of an embodiment of a device 200 that includes automated calibration circuitry, such as a reference light source 218, a reference photodetector 220, and controller circuitry 222. The light rays and the particle are not shown in FIG. 3 to not obscure the view of the connections between components of the device 200. The device 200 is like the device 100, with the device 200 including a reference light source 218, a reference photodetector 220, controller circuitry 222, and a light filter 224.

The reference light source 218 can include one or more light emitting diodes (LEDs). The reference light source 218 can be controlled, by the controller circuitry 222, such as can include a pulse-width controlled digital to analog converter, to emit light pulse signals that are sensed by the PMTs and measured by analog-to-digital converters to have amplitudes, time durations, or wavelength bands that can be matched to signals that match fluorescent calibration particles. The optical intensity emitted by the reference light source 218 can be dependent on temperature and aging. Without external feedback control, the reference light source 218 does not provide a reliably repeatable light source. Consequently, embodiments include the reference photodetector 220, such as a SiPD or other stable or protected photodetector, such as a protected CCD. A protected photodetector can include a SiPD or CCD covered or otherwise protected from an external environment. A protected photodetector can include a shutter, such as can be controlled by the controller circuitry 222. The shutter is a device that opens and closes to expose the measurement photodetector 112A or 112B to light or to block light from the measurement photodetector 112A or 112B.

The reference photodetector 220 can produce an electrical signal that is proportional to the intensity of light incident thereon, such as a light from the reference light source 218. The reference photodetector 220 signal can be measured by an analog to digital converter of the controller circuitry 222 to provide a control input to the controller circuitry 222. The reference light source 218 and the reference photodetector 220 can be mounted inside the device 200. SiPDs are stable photodetectors with very little sensitivity to temperature, aging, or other intrinsic or extrinsic factors, and are commonly used in optical power meters and other devices requiring accurate photosensitivity. Unlike APDs and PMTs, SiPDs and CCDs have no signal multiplication after the initial photoemission. Unlike PMTs, CCUs, and APDs, SiPDs are not suitable for low intensity signals such intrinsic fluorescence from a small (1 to 10 micrometer) microbial particle in a flow stream However, despite their limited sensitivity, SiPDs are made useful in embodiments by locating them in proximity to the reference light source 218 such that an adequate signal from the reference light source 218 is incident on the reference photodetector 220. The reference light source 218 can illuminate the measurement photodetector 112A-112E (see FIGS. 2-5) indirectly, such as by scattering light from an aerosol inlet nozzle and the interior of the optical chamber. The reference light source 218 can produce a low intensity light signal at the measurement photodetector 112A-112E.

Optical filter 224, such as a neutral density filter, can be situated between the reference light source 218 and the measurement photodetector 112A-112B or 112D-112E, such as to help provide a low intensity light signal to the measurement photodetector 112A-112B or 112D-112E. The filter 224 includes one or more optical filters that condition light incident thereon. The filter 224 selectively transmits light of certain wavelengths. The filter 224 can allow light to be detected by the measurement photodetector 112A-112B to pass therethrough to the dichroic mirror 106, while blocking other light.

The controller circuitry 222 can be situated in, on, near, or more remotely to the device 200, so long as it can send electrical signals to the particle illumination light source 102 or reference light source 218 and receive electrical signals from the reference photodetector 218 and the measurement photodetector 112A-112E. It can be advantageous for the controller circuitry 222 to receive output from analog-to-digital converter(s) that are used for normal use by the measurement photodetector 112A-112E. The controller circuitry 222 can include a microcontroller, or other programmable digital processing circuitry, such as a field programmable gate array (FPGA). The controller circuitry 222 can provide, via a digital-to-analog converter or equivalent, signals to the reference light source 218 to control the reference light source 218, including the intensity of light produced by the reference light source 218, the pulse duration, or the duty cycle of the light emissions from the reference light source 218. The controller circuitry 222 can provide one or more signals to one or more of the measurement photodetector 112A-112E to control a gain thereof. The controller circuitry 222 can provide one or more signals to the reference light source 218, such as to select an LED of a plurality of LEDs to produce light. The plurality of LEDs can include LEDs that produce light of distinct colors.

In operation, the reference light source 218 illuminates a region of the device 200 in which the reference photodetector 220 is situated and through which the light may be transmitted to the measurement photodetector 112A-112B. The wavelength of the reference light source 218 can be within a waveband of the measurement photodetector 112A-112B. The reference light source 218 amplitude intensity, power, or the like) can be sensitive to aging, provided power, temperature, or the like. The reference photodetector 220 can sense the reference light source 218 and provide one or more signals to the controller circuitry 222 indicating an intensity of the light incident thereon (from the reference light source 218). The controller circuitry 222, in response to the signals from the reference photodetector 220, can adjust an intensity of the reference light source 218, such as to make the intensity, detected by the reference photodetector 220, fall within a specified range of intensities (e.g., a target value plus and/or minus a specified percentage, such as a specified range of target intensity values). The reference light source 218 will then produce light at the calibrated intensity. The measurement photodetector 112A-112B can be illuminated by light at the calibrated intensity from the reference light source 218. The measurement photodetector 112A-112B can produce signals indicative of an amount of light incident thereon. The controller circuitry 222 can produce signals that adjust the gain of the measurement photodetector 112A-112B so that the measurement photodetector 112A-112B produces a signal within a specified range of signal values (e.g., a range of target photodetector values) in response to the light at the calibrated intensity. The controller circuitry 222 can adjust the gain of the measurement photodetector 112A-112B, such as by a digital-to-analog converter, which in turn controls the high voltage bias of the measurement photodetector 112A-112B. A typical bias voltage of a PMT is about 400 to 1000 volts. The value of the high voltage bias controls the multiplication gain, or sensitivity, of the measurement photodetector 112A-112B. Alternate means of controlling the gain are also possible, such as by a voltage controlled amplifier, with the control voltage provided by a digital-to-analog converter connected to a microcontroller. In this manner, the measurement photodetector 112A-112B can be calibrated. The calibration causes the measurement photodetector 112A-112B to produce a signal value within a specified range of values in response to the light source 218. As the light from the reference light source 218 can go through the filter 224 (in embodiments that include the filter 224), the calibration can also account for changes in the filter 224.

The process of calibrating the device 200 can be repeated for each measurement photodetector 112A-112E (see FIGS. 2-5). In one or more embodiments, the measurement photodetectors 112A-112B are configured to detect different wavelengths of light. For example, the photodetector 112A may detect wavelengths primarily in the yellow spectral regions and the photodetector 112B may detect wavelengths primarily in the blue spectral region. In this example, the reference light source 218 may include two LEDs, one emitting yellow light and the other emitting blue light. Multiple colors of LEDs can be available in the same package.

FIG. 4 illustrates, by way of example, a top-view diagram of an embodiment of a system 400 for calibrating a measurement photodetector (e.g., an HSPD). The system 400 includes components like the device 200 with the system 400 including first mirror portions 302A and 302B, second mirror portions 304A and 304B, an APD 112C, which is a specific example of a measurement photodetector, and a collimating device 308. The system 400 includes a UV laser 102A, which is a specific example of the particle illumination light source 102. The system 400 includes an LED 218A, which is a specific example of the reference light source 218. The system 400 includes PMTs 112D and 112E, which are specific examples of the measurement photodetectors 112A-B. The system 400 includes a SiPD 220A, which is a specific example of the reference photodetector 220. A particle can be provided “into the page”, with particles illuminated by the light from the UV laser 102A passing between the first mirrors portions 302A and 302B and the second mirrors portions 304A and 304B.

In FIG. 4, different symbols on a line indicate different light. For example, “v” indicates light from the UV laser 102A, “x” indicates light from the UV laser 102A after scattering off the particle 119, “w” indicates light from the LED 218A, and so on.

The first mirror portions 302A and 302B direct light from the UV laser 102A that has been scattered by a particle onto the APD 112C. The gain of the APD 112C can be adjusted by the controller circuitry 222. The first mirror portions 302A and 302B may be parts of a single ellipsoidal mirror with a hole therein, through which light can pass.

The second mirror 304A and 304B direct light from the UV laser 102A that has been scattered by a particle onto the filter 224. The filter 224 can block light at the color (or range of colors) produced by the UV laser 102A. The filter 224 can pass light of fluorescence wavelengths to the dichroic mirror 106. The second mirror portions 304A-304B, like the first mirror portions 302A-302B, may be parts of a single ellipsoidal mirror with a hole therein, through which light can pass.

The collimating device 308 receives filtered light from the filter 224 or passed through the mirror portions 302A-302B (in embodiments that do not include the filter 224). The collimating device 308 produces parallel rays of light. The collimating device 308 limits an amount that light emanating therefrom can spread.

The dichroic mirror 106 separates the light from the collimating device 308 into two emission wavelength bands for detection by respective PMTs 112D and 112E. The signals acquired for each particle and provided by the PMT 112D or 112E, or APD 112C can be digitized, by an analog-to-digital converter of the controller circuitry 222. The controller circuitry 222 can determine a particle's viability based on the signals.

For calibration, the LED 218A can be commanded, by the controller circuitry 222, to produce light at a specific intensity, pulse width, or duty cycle. The SiPD 220A, can receive light from the LED 218A and produce one or more signals indicating an intensity of the light incident thereon. It can be advantageous for the controller circuitry 222 to turn off UV laser 102A, for the duration of an automated calibration process so that signals from actual particles do not interfere with the calibration. The controller circuitry 222 can receive the signals from the SiPD 220A and determine whether the signals indicate light of a sufficient intensity (light within 1%, 2%, 3%, 4%, etc. of a target intensity value). If the intensity value is not of sufficient intensity, the controller circuitry 222 can adjust an operating power, or other parameter of the LED 218A until the SiPD 220A registers light of a sufficient intensity. The LED 218A can then generate a signal at the sufficient intensity. Light from the LED 218A, typically one or more LEDs, is scattered within the optical chamber (area between the first mirror portions 302A-302B and the second mirror portions 304A-304B) so that this indirect light path produces a low-level signal comparable to the signals from the calibration particles. The response of the APD 112C can be compared to a desired response, such as by the controller circuitry 222. The controller circuitry 222 can adjust a sensitivity of the APD 112C via a high voltage bias until the APD 112C provides a response that is within a threshold percentage of the desired response.

The controller circuitry 222 (if it has not already done so) can set the LED 218A to produce light of a wavelength that is passed by the filter 224 or the dichroic mirror 106 (in embodiments that include the filter 224 or the dichroic mirror 106) to the PMT 112D. The controller circuitry 222 can calibrate the intensity of the LED 218A in a manner previously discussed. After the LED 218A is producing light at the proper color and intensity, a response of the PMT 112D to the light from the LED 218A can be provided to the controller circuitry 222. The controller circuitry 222 can determine if the response of the PMT 112D is within a threshold percentage of a desired response. The controller circuitry 222 can adjust a gain of the PMT 112D until the response of the PMT 112D is within the threshold percentage of the desired response.

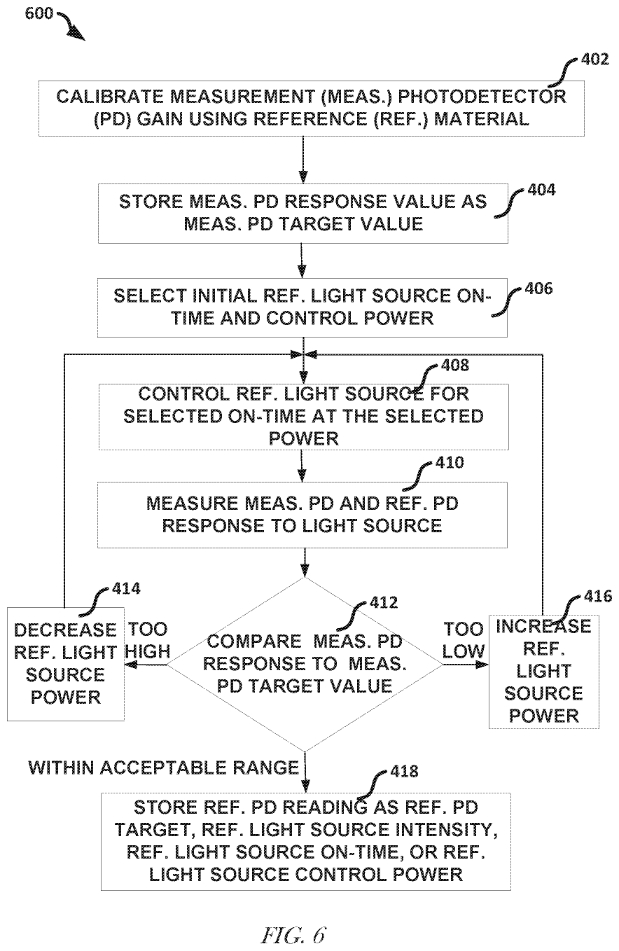

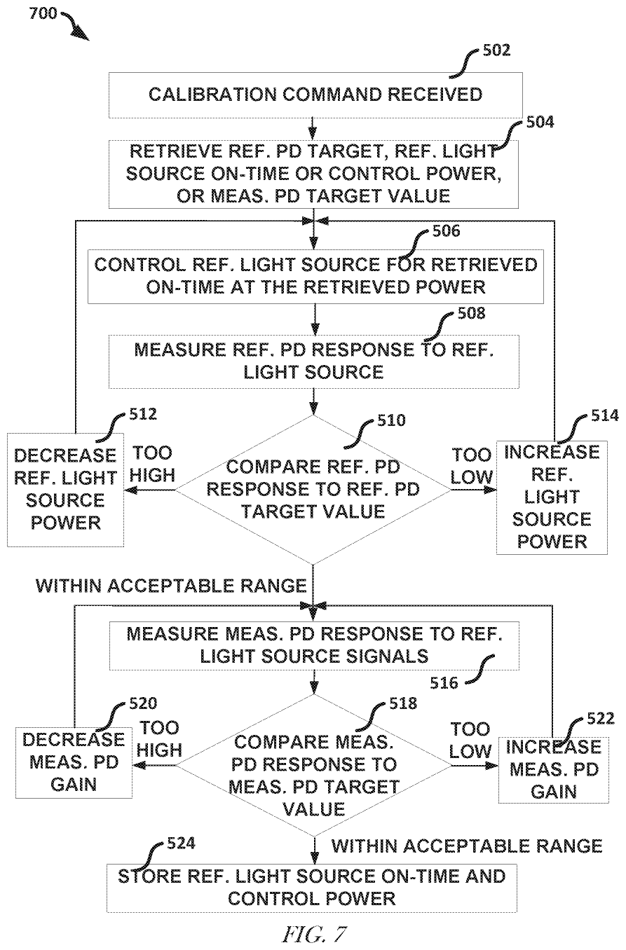

The controller circuitry 222 can set the LED 218A to emit light of a color that is passed by the filter 224 and the dichroic mirror 106 (in embodiments that include the filter 224 or the dichroic mirror 106) to the PMT 112E. Calibration of the PMT 112E can proceed in a manner like that of the PMT 112D. A desired response of any of the PMTs 112C-112E can be determined using a reference material as discussed at least regarding FIGS. 6 and 7.

FIG. 5 illustrates, by way of example, a side view diagram of an embodiment of a device 500. The device 500 illustrates relative positions of the particle illumination light source 102 and the reference light source 218 (reference light sources 218A and 218B are specific instances of the reference light source 218), an optical chamber 324, and a light stop assembly 326. The device 500 illustrates alternative positions for the reference light source 218 (illustrated as reference light source 218A and reference light source 218B). One position for the reference light source 218A is external to the optical chamber 324 and the light stop assembly 326. Another possible position for the reference light source 218B is internal to the light stop assembly 326. The reference photodetector 220 is illustrated as being internal to the light stop assembly 326.

The optical chamber 324 is the region in which the light from the particle illumination light source 102 is scattered and the region in which particles are introduced through the particle inlet 104. The optical chamber 324 can include mirrors, such as first mirror portions 302A-302B and second mirror portions 304A-304B as shown in FIG. 4 (omitted in FIG. 5 so as not to obscure the view of the components shown). The controller circuitry 222 can be external, but coupled to, selected components of the device 500. The controller circuitry 22.2 can include circuitry to control calibration of the device 500. In one or more embodiments, separate controllers can be used to control the operation of the particle illumination light source 102 or operation of the reference light source 218.

The circuitry of the controller circuitry 222 can include one or more digital to analog converters (DACs) and can provide control signals to the reference light source 218A or 218B. The circuitry of the controller circuitry 222 can include one or more analog to digital controllers (ADCs) to convert signals from the reference light source 218A or 218B to a form understandable by processing circuitry of the controller circuitry 222. The processing circuitry can include one or more resistors, transistors, inductors, capacitors, oscillators, regulators, logic gates (e.g., AND, OR, NAND, NOR, EXOR, negate, or other logic gates), amplifiers, multiplexers, buffers, memories, switches, summation devices, or the like, configured to control operation of one or more components of the device 500. The processing circuitry, in one or more embodiments can include a microcontroller, a field programmable gate array (FPGA), or the like.

Regarding FIGS. 2-5, using a programmable controller (e.g., the controller circuitry 222) coupled to the reference light source 218, the measurement photodetector 112A-112E, or the reference photodetector 220 it is possible to calibrate the measurement photodetector 112A-112E or reference light source 218 more quickly, more accurately, and/or more efficiently than is possible using prior calibration techniques. What follows is a description of methods 600 and 700 for calibrating one or more of the reference light source 218, or photodetector 112A-112E.

FIG. 6 illustrates, by way of example, a diagram of an embodiment of a method 600 for calibrating a measurement photodetector e.g., the measurement photodetector 112A-112E), and a reference light source (e.g., the reference light source 218). The measurement photodetector gain referred to in the method 600 refers to a gain of the measurement photodetector 112A-112E. The reference photodetector referred to in the method 600 is the reference photodetector 220. In general, the method 600 determines a target light source intensity based on the measurement photodetector response to a reference standard. The method 600 as illustrated includes: calibrating a measurement photodetector gain using a reference material, at operation 402; storing an measurement photodetector response value (to light originating from the particle illumination light source 102 and emitted from the reference material) as a measurement photodetector target response, at operation 404; selecting an initial reference light source on-time and control power (for the reference light source 218), at operation 406; controlling the reference light source for a selected on-time at the selected power, at operation 408; measuring a measurement photodetector and reference photodetector response to the light from the reference light source, at operation 410; comparing the measurement photodetector response to the measurement photodetector target value, at operation 412; in response to determining the measurement photodetector response is greater than (or equal to) the measurement photodetector target value (plus an acceptable delta value) at operation 412, decreasing the reference light source power, at operation 414; in response to determining the measurement photodetector response is less than the measurement photodetector target value (minus an acceptable delta value) at operation 412, increasing the reference light source power, at operation 416; and in response to determining the measurement photodetector response is equal to the measurement photodetector target value (plus or minus an acceptable delta value) at operation 412, storing the reference photodetector reading as a reference photodetector target value for response to light source intensity, light source on-time, or control power, at operation 418.

The reference material, from operation 402, can include one or more microbeads that cause a known light scattering or fluorescence response from light produced by the particle illumination light source 102. The operation 408 can be performed multiple times, such as by pulsing the reference light source, or the like. The operation 410 can be performed multiple times, such as for each pulse produced at operation 408. The measurement photodetector and reference photodetector responses from operation 410 can be averaged to improve the accuracy of the reading, and may include removing outlier values.

FIG. 7 illustrates, by way of example, a diagram of an embodiment of a method 700 for calibrating a measurement photodetector (e.g., the photodetector 112A-112E) using a reference light source (e.g., the reference light source 218). The measurement photodetector gain referred to in the method 700 refers to a gain of the photodetector 112A-112E. The reference photodetector of the method 700 can include the photodetector 220. In general, the method 700 calibrates (automatically) a target reference light source intensity and a measurement photodetector gain based on detected reference light source intensity, such as can be based on a result of the method 600. The method 700 as illustrated includes: receiving a calibration command, at operation 502; retrieving the reference photodetector target value, reference light source on-time, reference light source control power, and measurement photodetector target value, at operation 504; controlling the reference light source for the retrieved on-time at the retrieved power, at operation 506; measuring reference photodetector response to the reference light source light, at operation 508; comparing the reference photodetector response to the reference photodetector target value, at operation 510; in response to determining the reference photodetector response is greater than the reference photodetector target value (plus an acceptable delta value) at operation 510, decreasing the reference light source power, at operation 512; in response to determining the reference photodetector response is less than (or equal to) the reference photodetector target value (minus an acceptable delta value) at operation 510, increasing the reference light source power, at operation 514; and in response to determining the reference photodetector response is equal to the reference photodetector target value (plus or minus an acceptable delta value) at operation 510, measure the measurement photodetector response to the reference light source light, at operation 516; comparing the measurement photodetector response to the retrieved measurement photodetector target value, at operation 518; in response to determining the measurement photodetector response is greater than (or equal to) the measurement photodetector target value (plus an acceptable delta value) at operation 518, decreasing the measurement photodetector gain, at operation 520; in response to determining the measurement photodetector response is less than the measurement photodetector target value (minus an acceptable delta value) at operation 518, increasing the measurement photodetector gain, at operation 522; and in response to determining the measurement photodetector response is equal to the measurement photodetector target value (plus or minus an acceptable delta value) at operation 518, storing the reference light source on-time or control power, at operation 524.

The operation 506 can be performed multiple times, such as by pulsing the reference light source, or the like. The operation 508 can be performed multiple times, such as for each pulse produced at operation 506. The reference photodetector responses from operation 508 can be averaged, such as after removing outliers. The operation 516 can be performed multiple times, such as for each pulse produced by the reference light source at the retrieved light source power or on-lime that resulted in the reference photodetector response being with the acceptable range at operation 510. The measurement photodetector 112A-112E responses can be averaged, such as after removing outliers.

An initial or periodic calibration can include performing a calibration using reference standard fluorescent microbeads, such as by performing a portion of the method 600, and setting bias voltages (e.g., a gain) of the measurement photodetector 112A-112E. The bias voltages can be provided to the controller circuitry 222. A time frame in which to perform an auto-calibration can be stored in a memory accessible by the controller circuitry 222, such as can be remote or local to the controller circuitry 222. The bias voltages, reference light source on-time, reference light source control power, measurement photodetector target value, or reference photodetector target value can be stored in the memory. One or more of the operations or the results of the operations can be provided to a user through a user interface of the device 10, 100, 200, 300, or 500.

The method 600 or 700 can include turning off a particle illumination light source (e.g., the particle illumination light source 102). The method 600 or 700 can include pulsing a corresponding reference light source at a fixed width for N times and computing the median pulse amplitude read by the measurement photodetector 112A-112E. The method 600 or 700 can include using repeated measurement photodetector measurements as feedback to adjust the light source pulse amplitude to attain the measurement photodetector target value obtained for calibration particles. The method 600 or 700 can include turning the particle illumination light source on, such as after calibration is complete. Method 700 can be performed at a scheduled time, after a specified amount of time has elapsed, when a designated instrument function is executed, such as at the start or end of routine particle sampling, or otherwise after receiving a command to perform the calibration from the instrument control panel or from a command to the instrument microcontroller via a communication link from a remote location. The controller circuitry 222 can initiate the calibration process, such as in response to determining a specified amount of time has elapsed, a specified date or time has passed, or in response to receiving, from a user interface, a signal commanding initiation of the calibration process.

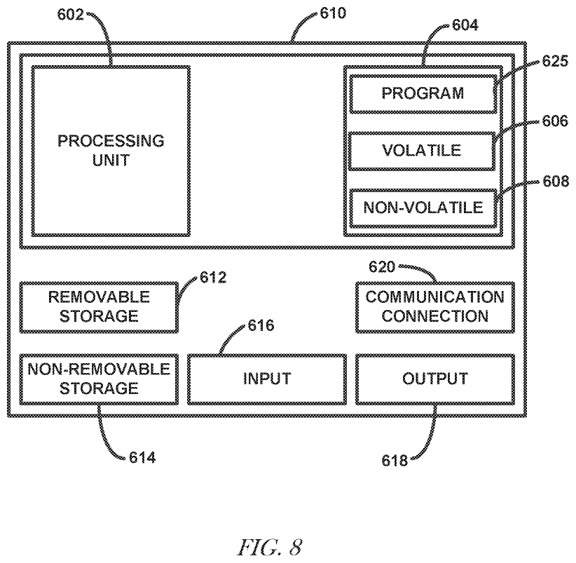

FIG. 8 illustrates, by way of example, a diagram of an embodiment of a computing device. One or more of the foregoing embodiments of the controller circuitry 222. or other circuitry or devices can include at least a portion of a computing device, such as the computing device of FIG. 8. The parameters, such as the measurement photodetector target value, reference photodetector target value, measurement photodetector gain, reference light source on-time, reference light source power, an amount to adjust the reference light source power, an amount to adjust the measurement photodetector gain, or the like, can be stored in a memory, such as the memory 604. In one or more embodiments, multiple such computer systems are utilized in a distributed network to implement multiple components in a transaction based environment. An object-oriented, service-oriented, or other architecture may be used to implement such functions and communicate between the multiple systems and components. One example computing device in the form of a computer 610 may include a processing unit 602, memory 604, removable storage 612, and non-removable storage 614. Memory 604 may include volatile memory 606 and non-volatile memory 608. Computer 610 may include—or have access to—a computing environment that includes—a variety of computer-readable media, such as volatile memory 606 and non-volatile memory 608, removable storage 612 and non-removable storage 614. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 610 may include or have access to a computing environment that includes input 616, output 618, and a communication connection 620. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a machine-readable storage device are executable by the processing unit 602 of the computer 610. A hard drive, CD-ROM, and RAM are some examples of articles including a non-transitory computer-readable medium. For example, a computer program 625 capable of providing instructions, which when executed by the processing unit 602 or other machine capable of executing the instructions, cause the processing unit to perform allocation or assignment of PCI based on a location of a small cell, such as a small cell that is being deployed, The instructions can be saved on a CD-ROM and loaded from the CD-ROM to a hard drive of the computer 610. The computer-readable instructions can allow the computer 610 (e.g., the processing unit 602) to implement the conflict detection, conflict avoidance, position determination, alert issuance, or other operations or methods.

Additional Notes and Examples. The following Examples provide details of embodiments that can be used with or independent of details previously discussed,

Example 1 includes an optical particle characterization device comprising a particle illumination light source to produce first light, a reference light source to produce second light, a particle inlet situated to introduce a particle into a path of the first light, a reference photodetector to receive the second light, a measurement photodetector to receive the first light scattered by the particle and receive the second light, and controller circuitry to determine whether, based on a signal from the reference photodetector, an intensity of the reference light source is within a specified range of target intensity values, and in response to determining the intensity of the second light is within the specified range of target intensity values so that the reference light source is producing calibrated second light, determine whether a response to the calibrated second light of the measurement photodetector is within a specified range of target photodetector values.

In Example 2, Example 1 further includes, wherein the particle illumination light source includes a laser and the reference light source includes a light emitting diode.

In Example 3, at least one of Examples 1-2 further includes, wherein the reference photodetector includes a silicon photodiode (SiPD) and the measurement photodetector includes one of an avalanche photodiode (APD), a photomultiplier tube (PMT), and a charge-controlled device (CCD).

In Example 4, at least one of Examples 1-3 further includes, wherein the controller circuitry is further to control at least one of an operating power of the reference light source and a duty cycle of the reference light source, and control at least one of the operating power of the reference light source and duty cycle of the reference light source in response to determining that an intensity of the second light is outside the specified range of target intensity values.

In Example 5, at least one of Examples 1-4 further includes, wherein the controller circuitry is further to adjust a gain of the measurement photodetector based on the one or more signals from the measurement photodetector.

In Example 6, at least one of Examples 1-5 further includes, wherein the measurement photodetector is a first measurement photodetector and the device further comprises a second measurement photodetector, a dichroic mirror to separate light incident thereon into separate first and second emission wavelengths, the dichroic mirror situated to provide the first emission wavelengths to the first measurement photodetector and the second emission wavelengths to the second measurement photodetector, and wherein the controller circuitry is further to before calibration of the reference light source, provide a command to the reference light source that selects a first light emitting diode of the reference light source that emits light of a first color, calibrate the reference light source and the first measurement photodetector while the first light emitting diode emits light of the first color, provide a command to the reference light source that selects a second light emitting diode of the reference light source that emits light of a second color, calibrate the intensity of the reference light source based on signals from the reference photodetector, and in response to determining the intensity of the second light emitting diode is calibrated, calibrate a gain of the second measurement photodetector using the calibrated second light emitting diode.

In Example 7, at least one of Examples 1-6 further includes a filter between the particle illumination light source and the dichroic mirror, the filter to block light of a color produced by the particle illumination light source and allow light scattered from the particle to pass therethrough.

In Example 8, at least one of Examples 1-7 further includes a housing or shutter situated to protect the reference photodetector from an environment surrounding the reference photodetector.

In Example 9, at least one of Examples 1-8 further includes, wherein the controller circuitry is further to automatically produce a signal that causes the reference light source to illuminate the reference photodetector after a specified amount of time has elapsed, at a specified time, or in response to receiving a command through a user interface that indicates a calibration is to be performed.

Example 10 includes a method of calibrating a device, the method comprising providing, by a reference light source of the device, first light to a reference photodetector of the device, determining, by controller circuitry of the device, whether a first value from the reference photodetector produced in response to the first light is within a range of acceptable reference photodetector values, in response to determining the first value is within the range of acceptable reference photodetector values, providing, by the reference light source, second light to a measurement photodetector, determining, by the controller circuitry, whether a second value from the measurement photodetector produced in response to the second light is within a range of acceptable measurement photodetector values, and in response to determining the second value is not within the range of acceptable measurement photodetector values, adjusting a gain of the measurement photodetector.

In Example 11, Example 10 further includes, situating a reference material in a light path of the particle illumination light source of the device, and recording, at a memory of the device, a response of the measurement photodetector to light scattered by the reference material as an acceptable measurement photodetector value, wherein the range of acceptable measurement photodetector values includes the acceptable measurement photodetector value plus and minus a specified percentage.

In Example 12, at least one of Examples 10-11 further includes illuminating the measurement photodetector with third light from the reference light source, determining whether a response of the measurement photodetector to the third light is within the range of acceptable measurement photodetector values, and in response to determining the response of the measurement photodetector is within the range of acceptable measurement photodetector values, recording an operating power and duty cycle of the reference light source and a response of the reference photodetector as an acceptable reference photodetector value in the memory of the device, wherein the range of acceptable reference photodetector values includes the acceptable reference photodetector value plus and minus a specified percentage.

In Example 13, at least one of Examples 10-12 further includes providing, by the controller circuitry, a command that causes the reference light source to produce light of a second color, and calibrating a second measurement photodetector using the light of the second color.

In Example 14, at least one of Examples 10-13 further includes, wherein the reference light source includes a light emitting diode and the particle illumination light source includes a laser.

In Example 15, at least one of Examples 10-14 further includes, wherein the reference photodetector includes a silicon photodetector (SiPD) and measurement photodetector includes a photomultiplier tube (PMT) or avalanche photodiode (APD).

In Example 16, at least one of Examples 1-15 further includes, wherein providing, by a reference light source of the device, first light to a reference photodetector of the device includes providing commands that cause the reference light source to operate at the recorded operating power and duty cycle.

In Example 17, at least one of Examples 10-16 further includes automatically producing, by the controller circuitry, a signal that causes the reference light source to illuminate the reference photodetector after a specified amount of time has elapsed, at a specified time, or in response to receiving a command through a user interface that indicates a calibration is to be performed.

Example 18 includes a non-transitory machine-readable storage device including instructions stored thereon that, when executed by a machine, configure the machine to perform operations for calibrating, the operations comprising providing a first command that configures a reference light source of a device to produce first light incident on a reference photodetector of the device, determining whether a first value from the reference photodetector produced in response to the first light is within a range of acceptable reference photodetector values, in response to determining the first value is within the range of acceptable reference photodetector values, providing a second command that configures the reference light source to produce second light incident on a measurement photodetector, determining whether a second value from the measurement photodetector produced in response to the second light is within a range of acceptable measurement photodetector values, and in response to determining the second value is not within the range of acceptable measurement photodetector values, providing a third command that adjusts a gain of the measurement photodetector.

In Example 19, Example 18 further includes, wherein the operations further comprise recording a response of the measurement photodetector to light from a particle illumination light source scattered off a reference material as an acceptable measurement photodetector value, wherein the range of acceptable measurement photodetector values includes the acceptable measurement photodetector value plus and minus a specified percentage.

In Example 20, at least one of Example 18-19 further includes, wherein the operations further comprise, in response to determining the response of the measurement photodetector is within the range of acceptable measurement photodetector values, recording an operating power and duty cycle of the reference light source and a response of the reference photodetector as an acceptable reference photodetector value in a memory of the device, wherein the range of acceptable reference photodetector values includes the acceptable reference photodetector value plus and minus a specified percentage.

In Example 21, at least one of Examples 19-20 further includes, wherein the first light is of a first color, and the operations further comprise providing a command that causes the reference light source to produce light of a second color; and calibrating a second measurement photodetector using the of the second color.

In Example 22, at least one of Examples 18-21 further includes, wherein the reference light source includes a light emitting diode, the particle illumination light source includes a laser, the reference photodetector includes a silicon photodetector (SiPD), and measurement photodetector includes a photomultiplier tube (PMT) or avalanche photodiode (APD).

In Example 23, at least one of Examples 18-22 further includes, wherein providing the first command that configures the reference light source of a device to produce first light includes providing commands that cause the reference light source to operate at the recorded operating power and duty cycle.

In Example 24, at least one of Examples 18-23 further includes, wherein the operations further comprise automatically producing a signal that causes the reference light source to illuminate the reference photodetector after a specified amount of time has elapsed, at a specified time, or in response to receiving a command through a user interface that indicates a calibration is to be performed.

Included in the disclosed subject matter provided herein are various system and method diagrams describing various embodiments of the particulate matter sensor calibration system. Therefore, the description above includes illustrative examples, devices, systems, and methods that embody the disclosed subject matter. In the description, for purposes of explanation, numerous specific details were set forth in order to provide an understanding of various embodiments of the inventive subject matter. It will be evident, however, to those of ordinary skill in the art that various embodiments of the inventive subject matter may be practiced without these specific details. Further, well-known structures, materials, and techniques have not been shown in detail, so as not to obscure the various illustrated embodiments.

As used herein, the term “or” may be construed in an inclusive or exclusive sense. Additionally, although various exemplary embodiments discussed herein focus on ways to calibrate a particle counter, other embodiments will be understood by a person of ordinary skill in the art upon reading and understanding the disclosure provided. Further, upon reading and understanding the disclosure provided herein, the person of ordinary skill in the art will readily understand that various combinations of the techniques and examples provided herein may all be applied in various combinations.

Although various embodiments are discussed separately, these separate embodiments are not intended to be considered as independent techniques or designs. As indicated above, each of the various portions may be inter-related and each may be used separately or in combination with other particle counter or other system embodiments discussed herein.

Consequently, many modifications and variations can be made, as will be apparent to the person of ordinary skill in the art upon reading and understanding the disclosure provided herein. Functionally equivalent methods and devices within the scope of the disclosure, in addition to those enumerated herein, will be apparent to the skilled artisan from the foregoing descriptions. Portions and features of some embodiments may be included in, or substituted for, those of others. Such modifications and variations are intended to fall within a scope of the appended claims. Therefore, the present disclosure is to be limited only by the terms of the appended claims, along with the full scope of equivalents to which such claims are entitled. It is also to be understood that the terminology used herein is for describing embodiments only and is not intended to be limiting.

The Abstract of the Disclosure is provided to allow the reader to quickly ascertain the nature of the technical disclosure. The abstract is submitted with the understanding that it will not be used to interpret or limit the claims. In addition, in the foregoing Detailed Description, it may be seen that various features may be grouped together in a single embodiment for streamlining the disclosure. This method of disclosure is not to be interpreted as limiting the claims. Thus, the following claims are hereby incorporated into the Detailed Description, with each claim standing on its own as a separate embodiment.

1. An optical particle characterization device comprising:
a particle illumination light source to produce first light;
a reference light source to produce second light;
a particle inlet situated to introduce a particle into a path of the first light;
a reference photodetector to receive the second light;
a measurement photodetector to receive the first light scattered by the particle and receive the second light; and
controller circuitry to:
determine whether, based on a signal from the reference photodetector, an intensity of the reference light source is within a specified range of target intensity values; and
in response to determining the intensity of the second light is within the specified range of target intensity values so that the reference light source is producing calibrated second light, determine whether a response to the calibrated second light of the measurement photodetector is within a specified range of target photodetector values.

2. The optical particle characterization device of claim 1, wherein the particle illumination light source includes a laser and the reference light source includes a light emitting diode.

3. The optical particle characterization device of claim 1, wherein the reference photodetector includes a silicon photodiode (SiPD) and the measurement photodetector includes one of an avalanche photodiode (APD), a photomultiplier tube (PMT), and a charge-controlled device (CCD).

4. The optical particle characterization device of claim 1, wherein the controller circuitry is further to:
control at least one of an operating power of the reference light source and a duty cycle of the reference light source; and
control at least one of the operating power of the reference light source and duty cycle of the reference light source in response to determining that an intensity of the second light is outside the specified range of target intensity values.

5. The optical particle characterization device of claim 1, wherein the controller circuitry is further to adjust a gain of the measurement photodetector based on one or more signals from the measurement photodetector.

6. The optical particle characterization device of claim 1, wherein the measurement photodetector is a first measurement photodetector and the device further comprises:
a second measurement photodetector;
a dichroic mirror to separate light incident thereon into separate first and second emission wavelengths, the dichroic mirror situated to provide the first emission wavelengths to the first measurement photodetector and the second emission wavelengths to the second measurement photodetector; and
wherein the controller circuitry is further to:
before calibration of the reference light source, provide a command to the reference light source that selects a first light emitting diode of the reference light source that emits light of a first color,
calibrate the reference light source and the first measurement photodetector while the first light emitting diode emits light of the first color;
provide a command to the reference light source that selects a second light emitting diode of the reference light source that emits light of a second color,
calibrate the intensity of the reference light source based on signals from the reference photodetector; and
in response to determining the intensity of the second light emitting diode is calibrated, calibrate a gain of the second measurement photodetector using the calibrated second light emitting diode.

7. The optical particle characterization device of claim 6, further comprising a filter between the particle illumination light source and the dichroic mirror, the filter to block light of a color produced by the particle illumination light source and allow light scattered from the particle to pass therethrough.

8. The optical particle characterization device of claim 1, further comprising a housing or shutter situated to protect the reference photodetector from an environment surrounding the reference photodetector.

9. The optical particle characterization device of claim 1, wherein the controller circuitry is further to:
automatically produce a signal that causes the reference light source to illuminate the reference photodetector after a specified amount of time has elapsed, at a specified time, or in response to receiving a command through a user interface that indicates a calibration is to be performed.

10. A method of calibrating a device, the method comprising:
providing, by a reference light source of the device, first light to a reference photodetector of the device;
determining, by controller circuitry of the device, whether a first value from the reference photodetector produced in response to the first light is within a range of acceptable reference photodetector values;
in response to determining the first value is within the range of acceptable reference photodetector values, providing, by the reference light source, second light to a measurement photodetector;
determining, by the controller circuitry, whether a second value from the measurement photodetector produced in response to the second light is within a range of acceptable measurement photodetector values; and
in response to determining the second value is not within the range of acceptable measurement photodetector values, adjusting a gain of the measurement photodetector.

11. The method of claim 10, further comprising:
situating a reference material in a light path of a particle illumination light source of the device; and
recording, at a memory of the device, a response of the measurement photodetector to light scattered by the reference material as an acceptable measurement photodetector value, wherein the range of acceptable measurement photodetector values includes the acceptable measurement photodetector value plus and minus a specified percentage.

12. The method of claim 10, further comprising:
illuminating the measurement photodetector with third light from the reference light source;
determining whether a response of the measurement photodetector to the third light is within the range of acceptable measurement photodetector values; and
in response to determining the response of the measurement photodetector is within the range of acceptable measurement photodetector values, recording an operating power and duty cycle of the reference light source and a response of the reference photodetector as an acceptable reference photodetector value in the memory of the device, wherein the range of acceptable reference photodetector values includes the acceptable reference photodetector value plus and minus a specified percentage.

13. The method of claim 10, further comprising:
providing, by the controller circuitry, a command that causes the reference light source to produce light of a second color; and
calibrating a second measurement photodetector using the light of the second color.

14. The method of claim 11, wherein the reference light source includes a light emitting diode and the particle illumination light source includes a laser.

15. The method of claim 10, wherein the reference photodetector includes a silicon photodetector (SiPD) and measurement photodetector includes a photomultiplier tube (PMT) or avalanche photodiode (APD).

16. The method of claim 12, wherein providing, by a reference light source of the device, first light to a reference photodetector of the device includes providing commands that cause the reference light source to operate at the recorded operating power and duty cycle.

17. The method of claim 10, further comprising automatically producing, by the controller circuitry, a signal that causes the reference light source to illuminate the reference photodetector after a specified amount of time has elapsed, at a specified time, or in response to receiving a command through a user interface that indicates a calibration is to be performed.

18. A non-transitory machine-readable storage device including instructions stored thereon that, when executed by a machine, configure the machine to perform operations for calibrating, the operations comprising:
providing a first command that configures a reference light source of a device to produce first light incident on a reference photodetector of the device;
determining whether a first value from the reference photodetector produced in response to the first light is within a range of acceptable reference photodetector values;
in response to determining the first value is within the range of acceptable reference photodetector values, providing a second command that configures the reference light source to produce second light incident on a measurement photodetector;
determining whether a second value from the measurement photodetector produced in response to the second light is within a range of acceptable measurement photodetector values; and
in response to determining the second value is not within the range of acceptable measurement photodetector values, providing a third command that adjusts a gain of the measurement photodetector.

19. The non-transitory machine-readable storage device of claim 18, wherein the operations further comprise recording a response of the measurement photodetector to light from a particle illumination light source scattered off a reference material as an acceptable measurement photodetector value, wherein the range of acceptable measurement photodetector values includes the acceptable measurement photodetector value plus and minus a specified percentage.

20. The non-transitory machine-readable storage device of claim 18, wherein the operations further comprise, in response to determining the response of the measurement photodetector is within the range of acceptable measurement photodetector values, recording an operating power and duty cycle of the reference light source and a response of the reference photodetector as an acceptable reference photodetector value in a memory of the device, wherein the range of acceptable reference photodetector values includes the acceptable reference photodetector value plus and minus a specified percentage.

21. The non-transitory machine-readable storage device of claim 18, wherein the first light is of a first color, and the operations further comprise:
providing a command that causes the reference light source to produce light of a second color; and
calibrating a second measurement photodetector using the of the second color.

22. The non-transitory machine-readable storage device of claim 19, wherein the reference light source includes a light emitting diode, the particle illumination light source includes a laser, the reference photodetector includes a silicon photodetector (SiPD), and measurement photodetector includes a photomultiplier tube (PMT) or avalanche photodiode (APD).

23. The non-transitory machine-readable storage device of claim 20, wherein providing the first command that configures the reference light source of a device to produce first light includes providing commands that cause the reference light source to operate at the recorded operating power and duty cycle.

24. The non-transitory machine-readable storage device of claim 18, wherein the operations further comprise automatically producing a signal that causes the reference light source to illuminate the reference photodetector after a specified amount of time has elapsed, at a specified time, or in response to receiving a command through a user interface that indicates a calibration is to be performed.
